(19) United States
(12) Patent Application Publication
(10) Pub. No.: US 2012/0260515 A1
(43) Pub. Date: Oct. 18, 2012

(54) HYDRAULIC EXSICCATE DEVICE

(75) Inventor: Richard Pindell, Chimacum, WA (US)

(73) Assignee: PINDELL ENGINEERING INC., Port Townsend, WA (US)

(21) Appl. No.: 13/323,463

(22) Filed: Dec. 12, 2011

Related U.S. Application Data
(60) Provisional application No. 61/422,070, filed on Dec. 10, 2010.

(51) Int. Cl. F26B 21/08

(52) U.S. Cl. 34/81

(57) ABSTRACT

A hydraulic exsiccate device lessens the presence of or prevents water vapor from entering the fluid reservoir of hydraulic machines which helps to reduce or eliminate damage to hydraulic systems used in environments such as boating, utilities, construction, manufacturing, fishing, industrial, marine, agriculture, military, mining, and so on. The hydraulic exsiccate device eliminates hydraulic reservoir fill caps, and in their place, the hydraulic exsiccate device is used as a cover fitting for closing the fluid reservoir (configured to conduct hydraulic fluid in the hydraulic systems) which operates to lessen the presence of or prevent water vapor from entering the fluid reservoir.

### CROSS-REFERENCE TO RELATED APPLICATION

This application claims the benefit of Provisional Application No. 61/422,070, filed Dec. 10, 2010, which is incorporated herein by reference.

### BACKGROUND

Hydraulics is a field of engineering dealing with the mechanical properties of liquids. In power engineering, hydraulics is used for the generation, control, and transmission of power by the use of pressurized liquids. In mechanical engineering, hydraulic machines consist of machinery and tools that use liquid fluid power to do simple work. Heavy equipment is a common example. In this type of machine, hydraulic fluid is transmitted throughout the machine to various hydraulic motors and hydraulic cylinders and becomes pressurized according to the resistance present. Ironically, these hydraulic machines, with specialized liquids as a power medium, such as oil, cannot withstand the presence of water. Water condensates after moisture gradually accumulates in hydraulic machines as they operate. Because water cannot be easily compressed, it damages the hydraulic machines over time.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter. A device form of the present subject matter recites a hydraulic exsiccate device, which comprises an exsiccate device configured to contain exsiccate beads in a perforated body. The hydraulic exsiccate device further comprises a structural portion which includes a weep hole and clamps. The structural portion is pressed to a female port of a hydraulic system by the clamps so as to introduce the exsiccate device into the hydraulic system.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective, isometric diagram of an archetypical hydraulic exsiccate device in an assembled state in preparation for insertion into a female port of a hydraulic system in accordance with an embodiment;

FIG. 2 is a perspective, isometric diagram of an archetypical hydraulic exsiccate device in an assembled state being inserted into a female port of a hydraulic system in accordance with an embodiment;

FIG. 3 is a perspective, exploded, isometric diagram of an archetypical hydraulic exsiccate device in accordance with an embodiment;

FIG. 4 is a cross-sectional diagram of a front view of an archetypical hydraulic exsiccate device in an assembled state being inserted into a hydraulic system in accordance with an embodiment;

FIG. 5 is a cross-sectional diagram of a front view of an archetypical exsiccate device in accordance with an embodiment;

FIG. 6 is a cross-sectional diagram of a front view of an archetypical exsiccate device in accordance with an embodiment;

FIG. 7 is a perspective, isometric diagram of an archetypical exsiccate device in preparation for insertion into an archetypical renewal station in accordance with an embodiment; and

FIG. 8 is a perspective, isometric diagram of an archetypical exsiccate device being inserted into an archetypical renewal station in accordance with an embodiment.

### DETAILED DESCRIPTION

Various embodiments of a hydraulic exsiccate device lessen the presence of or prevent water vapor from entering the fluid reservoir of hydraulic machines, which helps to reduce or eliminate damage to hydraulic systems used in environments such as boating, utilities, construction, manufacturing, fishing, industrial, marine, agriculture, military, mining, and so on. Various embodiments of the hydraulic exsiccate device eliminate hydraulic reservoir fill caps, and in their place, various embodiments of the hydraulic exsiccate device are used as a cover fitting for closing the fluid reservoir (configured to conduct hydraulic fluid in the hydraulic systems) which operates to lessen the presence of or prevent water vapor from entering the fluid reservoir.

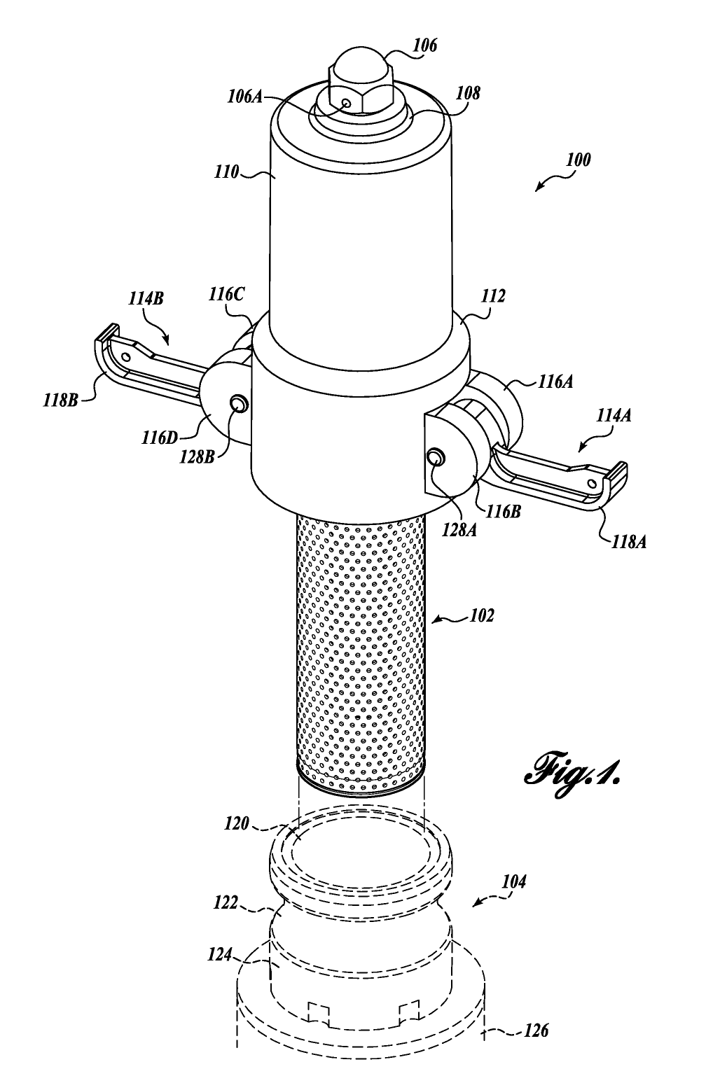

FIG. 1 is a perspective, isometric diagram of an archetypical hydraulic exsiccate device 100 in an assembled state (which includes an exsiccate device 102) in preparation for insertion into a female port 104 (such as a fluid reservoir) of a hydraulic system 126 in accordance with an embodiment of the present subject matter. The hydraulic exsiccate device 100 includes a lug keeper 106. The lug keeper 106 has a dome head integrally set on top of a nut with external faces to provide a grip. On the surface of one of the external faces of the nut is a weep hole 106a.

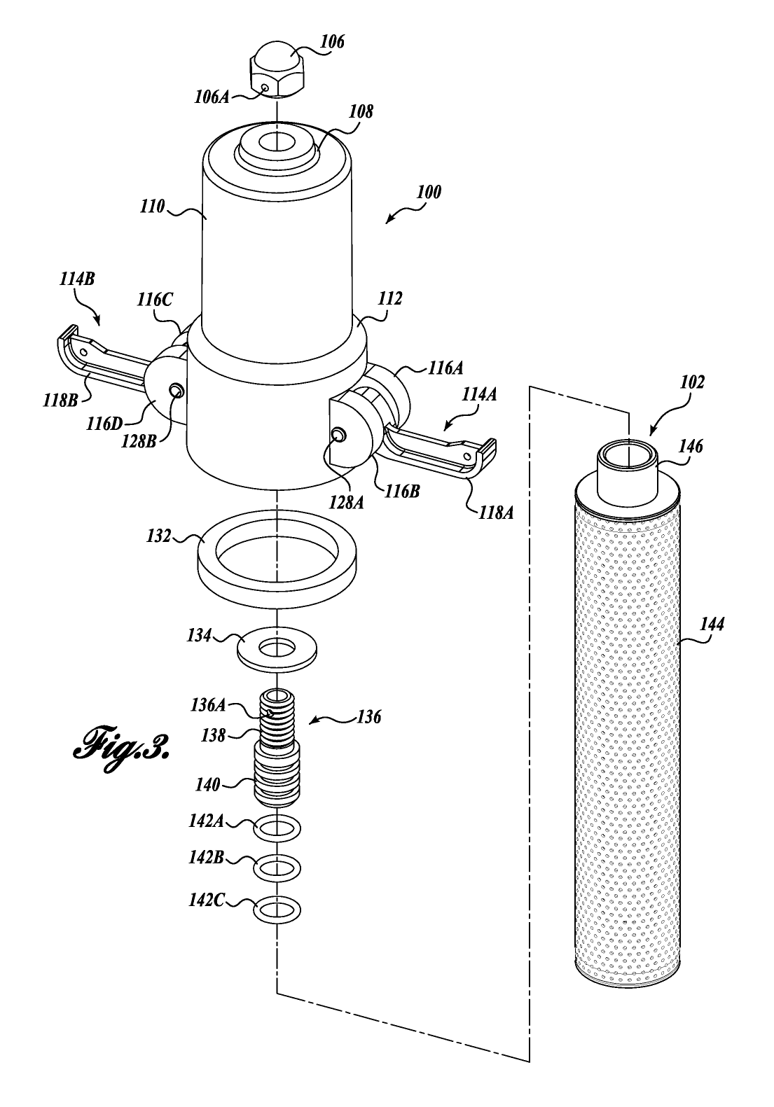

The weep hole 106a assists in the breathability of the hydraulic fluid in the hydraulic systems as the hydraulic fluid expands or contracts to power the hydraulic systems. The inner surfaces of both the dome head and the nut are a correspondingly grooved hollow cylinder into which fits a spirally grooved portion 138 (cylindrical in shape) of a fastener male fitting 136. (See FIG. 3.) The lug keeper 106 is configured to keep the exsiccate device 102 in position when inserted into the female port 104 above the hydraulic fluid of the hydraulic system 126 so as to inhibit the exsiccate device 102 from coming into contact with the hydraulic fluid of the hydraulic system 126.

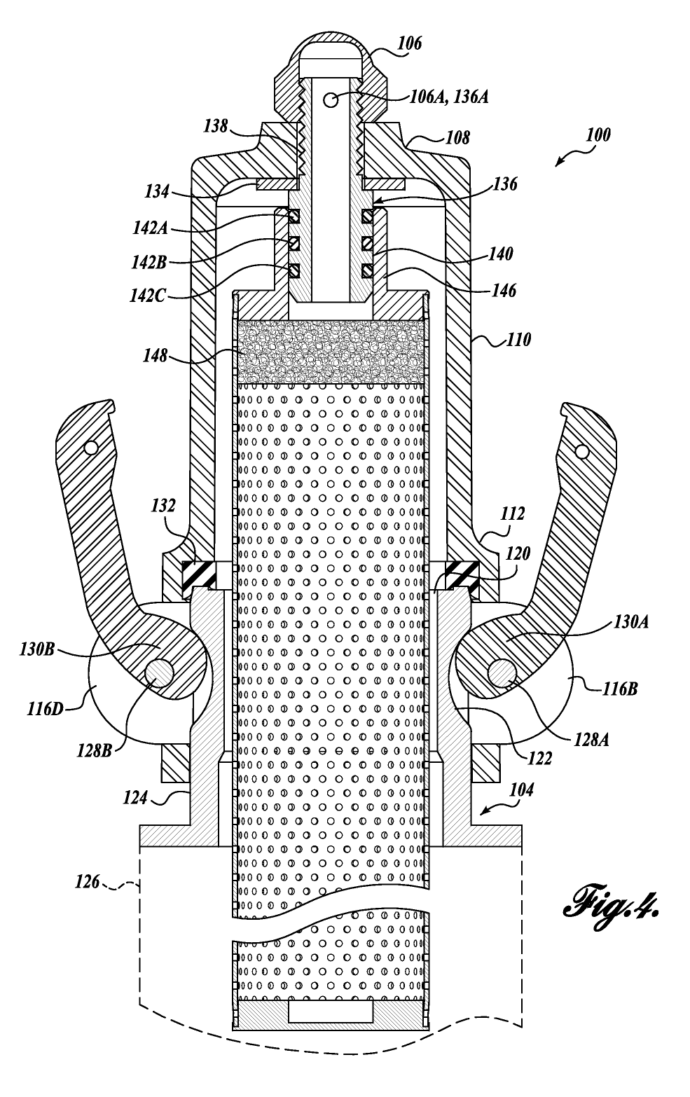

The lug keeper 106 is situated above a neck 108, which in one embodiment is cylindrical in shape. The fastener male fitting 136 passes through the neck 108 to reach the lug keeper 106 into which it is inserted. Situated on top of the neck 108 is a body 110, which in one embodiment is a hollowed cylinder to house the fastener male fitting 136 configured to communicate air through weep holes 106a, 136a and a portion of the exsiccate device 102. (See FIG. 4.) The body 110 is situated above a bottom 112, which in one embodiment is a hollowed cylinder to house a portion of the exsiccate device 102 and the female port 104.

On the external surface of the bottom 112 are two clamps 114a, 114b, which are located in opposed but symmetrical directions. The clamp 114a comprises two D-shaped base structures 116a, 116b, which are integrally projected from the external surface of the bottom 112, in parallel. Each D-shaped base structure 116a, 116b, has a hole, each of which is coaxially located with respect to each other. A clamp handle 118a has an arm, which arm terminates in a compression member 130a. (See FIG. 4.) The compression member 130a is configured to pivot into and out of a slot (not shown) defined between the two D-shaped base structures 116a, 116b. The compression member 130a has a hole (not shown). A rivet 128a unites the two D-shaped base structures 116a, 116b, and the clamp handle 118a by passing its shank through the holes of the two D-shaped base structures 116a, 116b, and the hole of the compression member 130a of the clamp handle 118a.

The other clamp on the external surface of the bottom 112 is the clamp 114b. The clamp 114b comprises two D-shaped base structures 116c, 116d, which are integrally projected from the external surface of the bottom 112, in parallel. Each D-shaped base structure 116c, 116d, has a hole, each of which is coaxially located with respect to each other. A clamp handle 118b has an arm, which arm terminates in a compression member 130b. (See FIG. 4.) The compression member 130b is configured to pivot into and out of a slot (not shown) defined between the two D-shaped base structures 116c, 116d. The compression member 130b has a hole (not shown). A rivet 128b unites the two D-shaped base structures 116c, 116d, and the clamp handle 118b by passing its shank through the holes of the two D-shaped base structures 116c, 116d, and the hole of the compression member 130b of the clamp handle 118b.

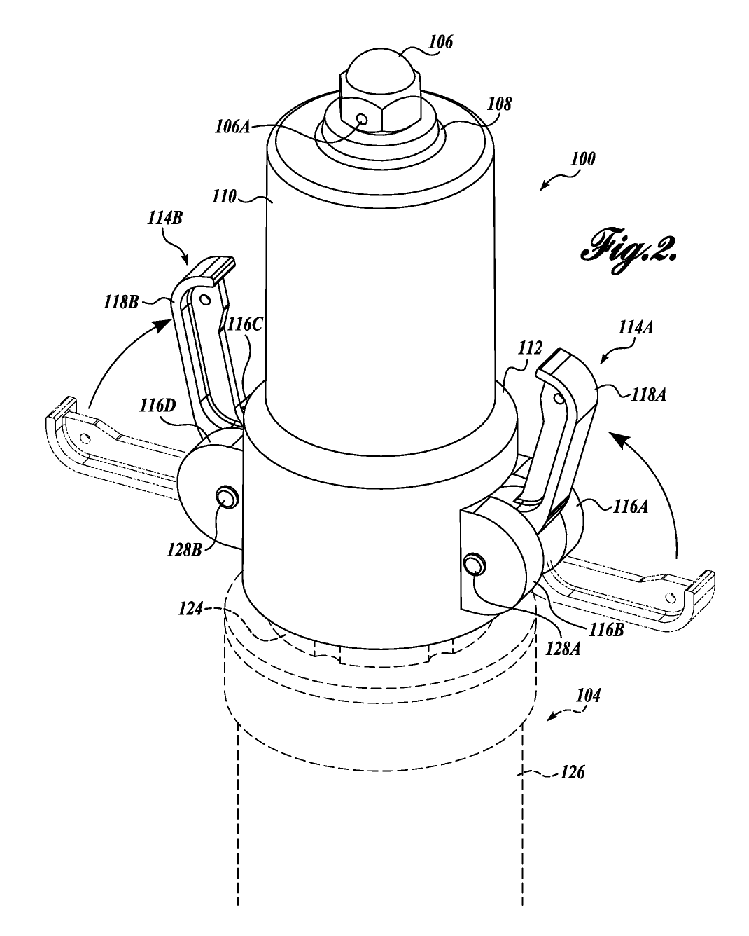

The female port 104 of the hydraulic system 126 comprises an annular opening 120, which is integral with the concave surface 122. The concave surface 122 is situated atop a cylindrical base 124. The cylindrical base 124 interfaces with the hydraulic system 126. FIG. 1 illustrates an opening orientation in which the clamp handles 118a, 118b, are in a rest position, which are actuated to be perpendicular to the bottom 112 of the hydraulic exsiccate device 100, each pointing away from the other. In the rest position, the compression members 130a, 130b do not press against the concave surface 122 of the female port 104, thereby allowing the hydraulic exsiccate device 100 to slide away or toward the female port 104. FIG. 2 illustrates the opening orientation by presenting the clamp handles 118a, 118b, in ghost form.

FIGS. 2 and 4 illustrate a closing orientation in which the clamp handles 118a, 118b are in an active position, which are actuated so as to be in parallel to the body 110 of the hydraulic exsiccate device 100, each pointing in the same direction as the other. In the active position, the compression members 130a, 130b, press against the concave surface 122 of the female port 104, to hold the bottom 112 of the hydraulic exsiccate device 100 firmly against the female port 104, while introducing the exsiccate device 102 into the female port 104, and further into the hydraulic system 126. FIG. 2 illustrates the closing orientation by presenting the clamp handles 118a, 118b, in solid form.

FIG. 3 is a perspective, exploded, isometric diagram of the hydraulic exsiccate device 100 in accordance with an embodiment. A structural portion of the hydraulic exsiccate device 100, as previously discussed, includes the lug keeper 106, the neck 108, the body 110, and the bottom 112 with the clamps 114a, 114b. A first O-ring 132 is used as a gasket which sits between the structural transition between the bottom 112 and the body 110 to make fluid-tight a joint created by the structural transition when the clamps 114a, 114b, are in the closing orientation. (See FIG. 4.) A washer 134 is a flat, thin ring sitting between the structural transition between a spirally grooved portion 138, and an annular grooved portion 140 of the fastener male fitting 136. The washer 134 is configured to sit against a top of the hollowed cylinder of the body 110 to ensure tightness, prevent or reduce leakage, or relieve tension when the fastener male fitting 136 is assembled into the hollowed cylinder of the body 110. (See FIG. 4.)

The fastener male fitting 136 is a hollowed cylinder, which has a weep hole 136a in the spirally grooved portion 138. The weep hole 136a suitably coaxially aligns with the weep hole 106a of the lug keeper 106 so as to communicate air through the weep holes 106a, 136a, through the hollowed cylinder of the fastener male fitting 136 to a neck 146 of the exsiccate device 102. (See FIG. 4.) O-rings 142a, 142b, and 142c sit in the annular grooves of the annular grooved portion 140 of the fastener male fitting 136. These O-rings 142a, 142b, and 142c act as gaskets to make a joint fluid tight between the annular groove portion 140 of the fastener male fitting 136 and the neck 146 of the exsiccate device 104. To be clear, the neck 146 of the exsiccate device 102 mates with the annular grooved portion 140 of the fastener male fitting 136 when the fastener male fitting 136 is inserted into the neck 146.

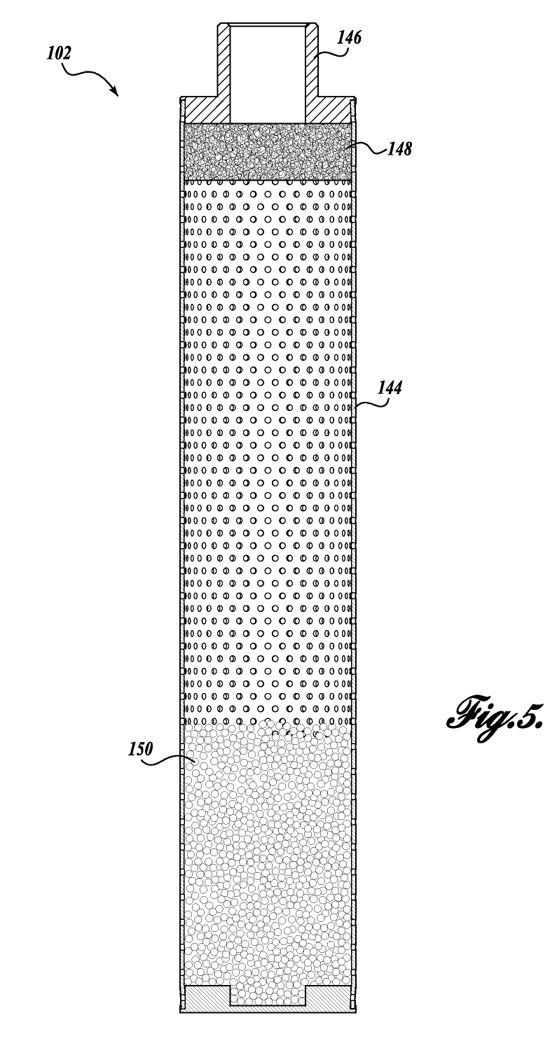

The exsiccate device 102 has a filter 148 to filter contaminants from the air when it is introduced into the neck 146 and prior to entering a body 144. In a few embodiments, the body 144 is entirely perforated. In other embodiments, the body 144 is partially perforated. For example, in these other embodiments, the body 144 is perforated at one end but not at the other end. In some embodiments, the body 144 is perforated in the middle but not at either end. FIG. 5 illustrates an embodiment where exsiccate beads partially fill the body 144. In another embodiment (not shown), the exsiccate beads completely fill the body 144.

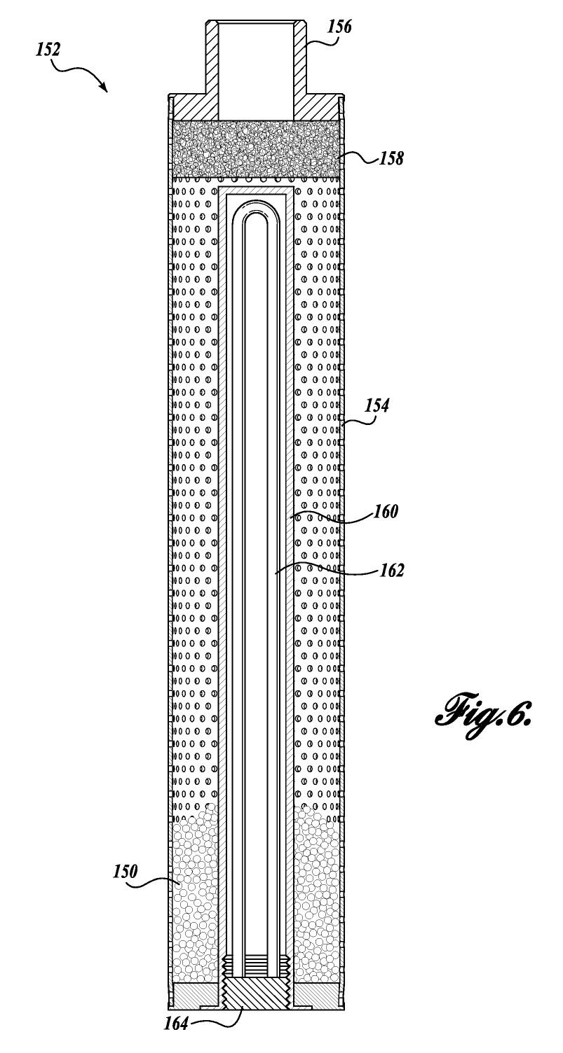

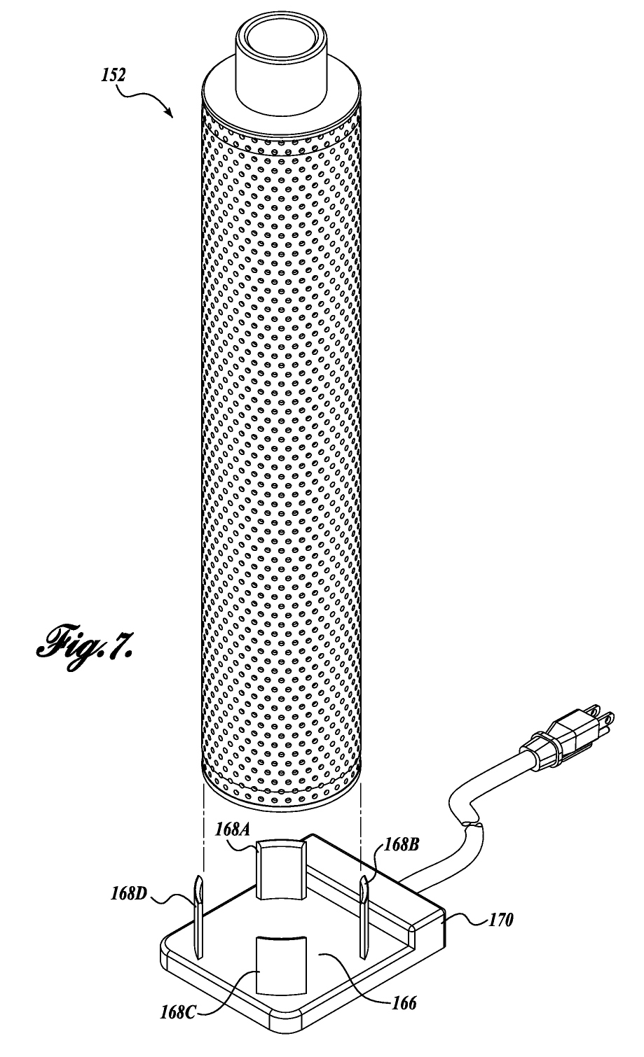

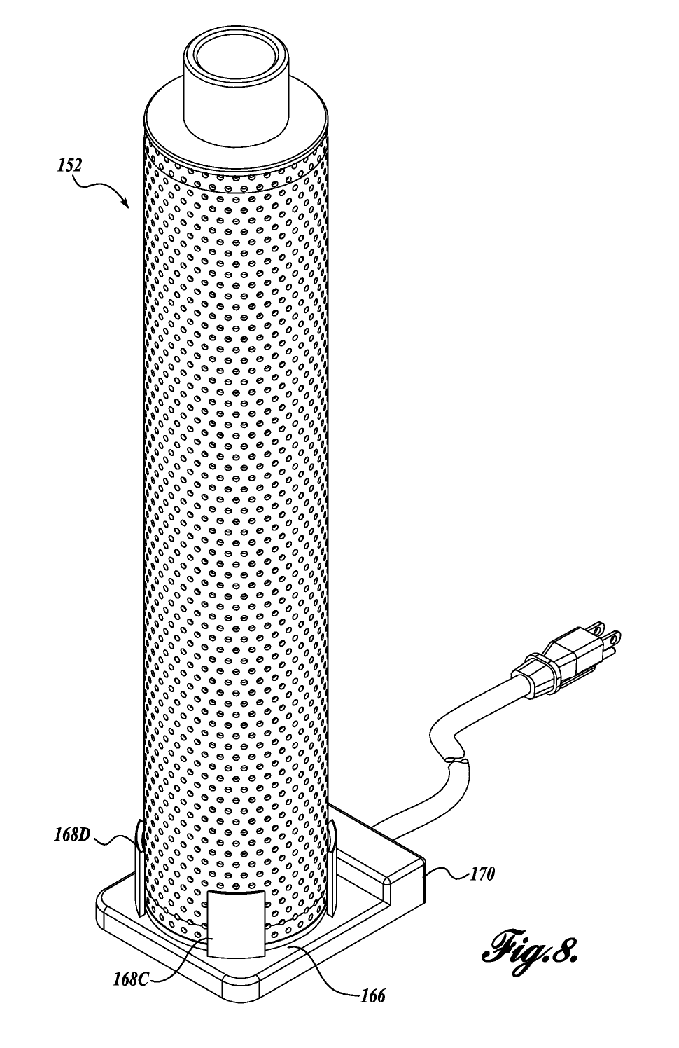

FIGS. 6, 7, and 8 illustrate a further embodiment of a cross-section of a front view of an exsiccate device 152, which is similar to the exsiccate device 102, albeit with some differences. The exsiccate device 152 has a neck 156, filter 158, and body 154. As would be appreciated by one skilled in the art, the exsiccate device 152 is not illustrated with exsiccate beads, which can partially fill or completely fill the body 154, so as to help focus on the mechanical structure of the exsiccate device 152. Inside the body 154 is a sheath 160, which houses a heated element 162. The heated element 162 communicates heat received by the thermal receiver 164 at a bottom of the body 154. When activated, the heated element 162 radiates heat causing the exsiccate beads to release captured water molecules.

To communicate heat to the heated element 162, the exsiccate device 152 is set on a thermal transmitter 166 so that the thermal receiver 164 is in communication with the thermal transmitter 166. The supporting fingers 168a, 168b, 168c, and 168d grip the body 154 of the exsiccate device 152 to stay it on the renewal station 170. The renewal station 170 can be plugged into an electrical outlet to activate. While illustrative embodiments have been illustrated and described, it will be appreciated that various changes can be made therein without departing from the spirit and scope of the invention.

The embodiments of the invention in which an exclusive property or privilege is claimed are defined as follows:

1. A hydraulic exsiccate device, comprising:
an exsiccate device configured to contain exsiccate beads in a perforated body; and
a structural portion which includes a weep hole and clamps, the structural portion being pressed to a female port of a hydraulic system by the clamps so as to introduce the exsiccate device into the hydraulic system.

2. The hydraulic exsiccate device of claim 1, further comprising a lug keeper formed from a dome head integrally set on top of a nut having multiple faces, one of the multiple faces having the weep hole, inner surfaces of the dome head and the nut having a grooved hollow cylinder.

3. The hydraulic exsiccate device of claim 2, further comprising a neck, body, and bottom, which are cylindrical in shape.

4. The hydraulic exsiccate device of claim 3, further comprising two clamps, each clamp including two D-shaped base structures and a clamp handle which has an arm that terminates in a compression member, the compression member being configured to pivot into and out of a slot defined between the two D-shaped base structures.

5. The hydraulic exsiccate device of claim 4, further comprising a fastener male fitting which is a hollowed cylinder, the fastener male fitting having a weep hole in a spirally grooved portion, and an annular grooved portion.

6. The hydraulic exsiccate device of claim 5, wherein the exsiccate device has a neck which is configured to mate with the annular grooved portion of the fastener male fitting.

7. The hydraulic exsiccate device of claim 6, wherein the perforated body of the exsiccate device is partially perforated.

8. The hydraulic exsiccate device of claim 6, wherein the perforated body of the exsiccate device is completely perforated.

9. The hydraulic exsiccate device of claim 6, wherein the perforated body of the exsiccate device houses a filter.

10. The hydraulic exsiccate device of claim 6, wherein the exsiccate device includes a heated element and a thermal receiver.
